(19) United States
(12) Patent Application Publication
(10) Pub. No.: US 2009/0198578 A1
(43) Pub. Date: Aug. 6, 2009

(54) Auction Inverse System

(76) Inventor: Muhammad Shams Mukhtar, San Diego, CA (US)

Correspondence Address: Muhammad Shams Mukhtar, 11746 Corte Templanza, San Diego, CA, 92128, US

(21) Appl. No.: 12/355,797

(22) Filed: Jan. 18, 2009

Related U.S. Application Data
(60) Provisional application No. 61/022,519, filed on Jan. 22, 2008.

(51) Int. Cl. G06Q 30/00

(52) U.S. Cl. 705/14

(57) ABSTRACT

In a traditional Auction, Auction of any item takes place at specific date and time and who so ever bids high wins. Here is totally revolutionary auction mechanism, I named it an “Inverse Auction System or Auction Inverse System”—In this system the items are listed by the auctioneer in the auction-store with no specific date and time of auction. The trigger/initiation of the auction event is in the hands of the bidders, not the auctioneer. When some prospective buyer/bidder likes the item, he/she will initiate the auction, and now we have right away a potential buyer for it. The starter of the auction, will get some rewards, like discounts in any form, may be a % x off or any number of rewards and best of all will be presented a onetime “Buy-it-now” and “Make-an-offer” options. In this way there is a better chance of auction as well as a race condition among bidders for the items. This will make the auction more fun, exciting and rewarding. Everyone will try to start the auction to get the rewards, in that way there would be a competition among bidders as well, that make this system more productive and robust. Complete Algorithm is explained in the [FIG. 1].

### CROSS-REFERENCE TO RELATED APPLICATIONS

This application claims the benefit of provisional patent Application No. 61/022,519, filed on 2008 Jan. 22 by the present inventor.

### FEDERALLY SPONSORED RESEARCH

Not Applicable

### SEQUENCE LISTING OR PROGRAM

Not Applicable

### BACKGROUND

This application relates to buyer-driven, in-store auction and computerized web based auction.

### PRIOR ART

In a traditional auction, as noted in U.S. Pat. No. 6,647,373 to Carlton-Foss, auctions are based on paper media require that formal documents be distributed on paper to prospective bidders, and that those bidders be found and identified for a period long enough prior to the close of the bidding process so that they are able to submit their bids. When a modification is made to a request, an entire round of communications is required with paper and voice to inform the bidders of the changes. The administrative overhead for setting up and carrying out a “bid” is so great that only complex; “big ticket” goods and services can reasonably be requisitioned using this method.

In the above mentioned traditional auction system, the sellers or auctioneers initiate auction of items at some specific period of time and who so ever bids high wins; this typical and older system is also sometimes referred to as Forward Auction System. Thereafter since the late 1990's the Internet has profoundly changed the business realities, providing many different auction web sites with lots of different options for going into the auction contract. They are both based on traditional and the newer ones. A noteworthy relatively newer one is the Reverse Auction System. It is basically an opposite to the Forward Auction System, that is it's a buyer driven, and a buyer proposed a price for an item being placed for Auction by multiple sellers/auctioneers and the sellers compete with each other and come up with some price and if it is close to the range to the buyer's suggested one, the auction ends or otherwise. There exists Priceline.com, U.S. Pat. No. 5,794,207 Walker et al. And Ubid.com that is a slightly different but also falls into the same category of Reverse-Auction System as noted in the U.S. Pat. No. 6,266,652 Godin et al.

All of the above are basically similar in nature and are improvements on each other. So a need exists for a system that is totally buyer-driven but at the same time should be competitive not only among the buyers but a competition should also exist among the bidders/buyers as well and that can only be achieved through some sort of race condition among the buyers and attracting to auction by making it more rewarding and fun.

### SUMMARY

Advantage of the Auction-Inverse System may include one or more of the following. The system is buyer-driven and attracts bidders to get rewards on the basis of the first come first serve basis. The bidder/prospective buyer who initiated the bidding will get the option of buy-it-now option once and only once and that might be the lowest price ever offered apart from the other rewards in the form of future coupons or free-shipping etc. So the auction initiator is the one who will get the most benefits and that drives the auction as well as creates race condition and made the auction more productive and fun to get into the auction.

Another advantage of the system would be the sellers/auctioneers first offer that is the buy-it-now would be very critical in selling their product in timely fashion as well as attracting bidders in the future. So it should be very competitive among the sellers and requires a great deal of understanding/awareness of the product sales and statistics of the product sellers, who sells most and how the marketing plan about the products on sale, sending emails etc. to the potential buyers etc.

It's also very much feasible for online auctions—where, usually in the traditional auction system, the auction is expired in a period of time and fee is charged, without the item being sold. While, in this revolutionary Inverse Auction System, since the item is listed but never have under-gone auction, by the auctioneer, there will be no fee involved. The only fees involved, might be listing of items, or leasing of the web space is involved.

This method, the “Auction Inverse System”, is not limited to online electronic commerce web-sites but also is equally applicable to physical Auction Houses.

### DRAWINGS

### Figures

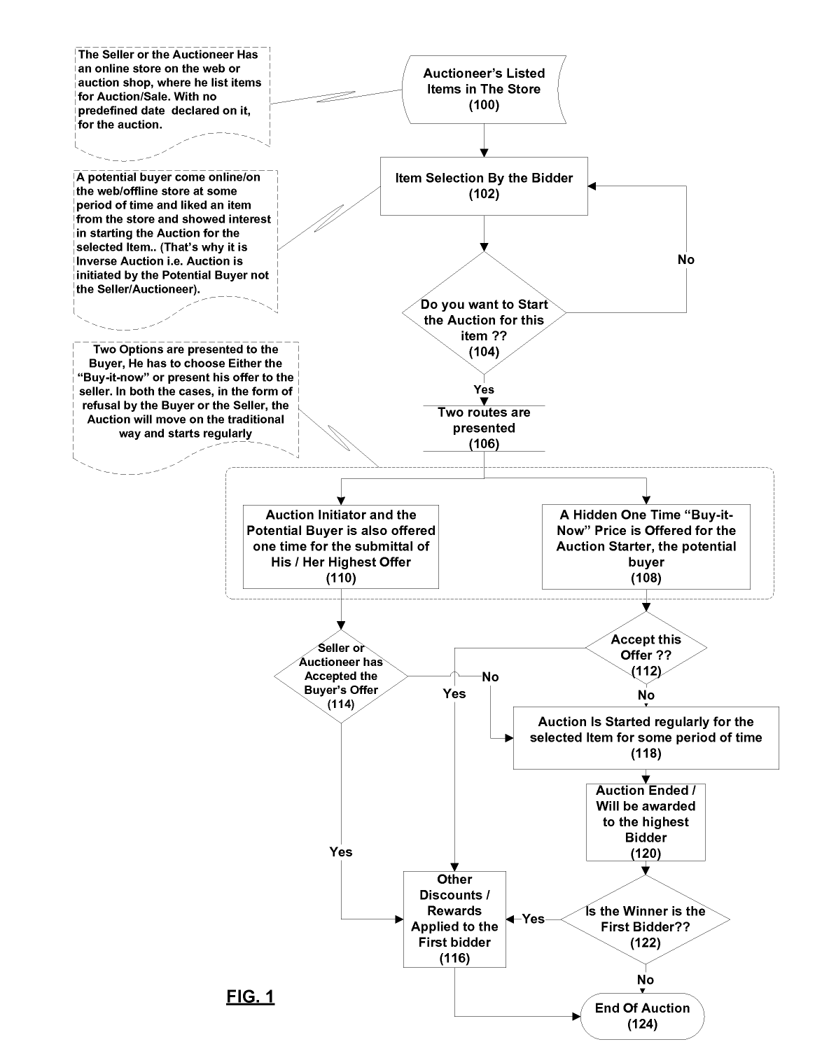

FIG. 1 shows a flowchart of different embodiments that constitute a buyer-driven Auction Inverse System.

### DRAWINGS

### Reference Numerals

100 Items Listed in the Auction House or Website
102 Item Selected by the Bidder
104 Confirmation by the Reverse Auction System
106 Presented the Choices available
108 Offered the one time “Buy-It-Now” Offer
110 Offered by the system/seller the one-time “Make an Offer” to the first Bidder/Buyer
112 Acceptance is needed from the first bidder/buyer
114 Acceptance is needed from the Reverse Auction System/Seller
116 Rewards applied if the winner is the first bidder
118 Traditional Auction Selected to continue
120 End of the Auction at predefined period of time by the System
122 Winner of the auction is evaluated and flagged if it's the bidder who started the auction.
124 End of the Auction—finalization is done according to the business rules defined in the Auction Inverse System.

### DETAILED DESCRIPTION

### FIG. 1—First Embodiment

Referring now to the drawing in a greater detail, illustrated therein the method/algorithm for the Auction Inverse System in the form of flow chart that describes the various steps involved in this process. It would also be the basis of the whole new online ecommerce based website/software that will be utilizing this system as well as may also be utilized for the offline auctioneers or product sellers.

FIG. 1 shows the Algorithm/Method for the Auction Inverse System as a flowchart. This revolutionary approach is a buyer-driven auction approach that is not dependent on the seller's enlistment of the products rather the auction only and only initiated when the first buyer selected an Item from the Auction House or the Online Auction Web-Site and thereafter the item is officially goes for the auction and the bidding will be stared afterwards.

Referring to (100) is the process of enlisting the product by the Auctioneer/Seller. The Seller has to have an online store or offline store or leased some space from some online/offline store for some period of time. As the purpose of illustration I'll consider an online ecommerce website that will be used for Auction purpose, but this could also be applicable to the physical auction houses. So the Auctioneer will list the Items on the web site with no predefined date declared for the auction. The items starting bid may or may not be disclosed at the time of enlistment of the item on the website. The business rules like this one is totally dependent on the web-site owners and the sellers/auctioneers and may vary auction to auction.

In (102) the prospective bidder/buyer comes on the website/store and liked some item from the store and showed interest in starting the auction for that particular item. There will also be options available for selecting multiple items and putting them in the basket and at some time later he/she wants to start the auction for all the items he selected in the basket. But in order to explain the system, we'll concentrate on one item that the bidder wants to start the auction.

In the (104) scenario, when the Bidder wants to initiate the auction for the selected item, he has been confirmed for his genuine interest in starting the auction and also presented a way to quit if he don't want to continue just in case it was mistakenly selected. But once he really confirmed for starting the auction, he/she will be entered into a legal bindings already disclosed to the buyer by the system.

In the (106) scenario, at the time of bid startup, the bidder has been presented with two onetime options i.e. “Buy-it-Now” (108) and “Make an Offer” (110) are presented. “Buy-It-Now” option may be the lucky/lowest one, and only is presented only once to the auction initiator and then forbidden forever and will never be disclosed to other bidders again afterwards. In the (108), if the Auction Initiator, The prospective buyer, accepted this Buy-it-Now offer, the Auction will be ended right away and proceeded to (116) that is other rewards, if any offered, will be applied and this buyer would be the Instant winner (124). In other words, the initiating of the auction means you have a potential buyer right away, that's the beauty of this Auction Inverse System.

In case of (110), the buyer/bidder who initiated the Auction is also presented with “Making an offer” option. If he selected this one and his offer is accepted by the seller/s, the bidder is the instant winner and proceeded to the (116) and finally to (124).

In case none of the above is applicable then the auction proceeds the traditional way accordingly as mentioned in (118) and last for some period of time according to the business rules defined by the Seller/Auctioneer at the time of listing the item on the website/store.

In the case of (120) we reach the end-time of the auction and the system will check if the ending bidder (122) is actually the one who initiated the auction then the rewards (116) will be applied and the auction will be concluded (124) otherwise the auction will be ended the regular way and no rewards will be applied (124).

### CONCLUSION, RAMIFICATIONS, AND SCOPE

This invention is a revolutionary and very different than the existing ones, because of its unique way of Initiation of the Auction. So the buyers, who need an item on urgent basis and on competitive rates need not to wait until a seller put the item for auction rather will be looking forward to take actions as quickly as possible to start an auction, because it's rewarding and you may get the item at the lowest price or at least at competitive rates.

Since it is buyer driven, it also permits the Initiating buyer to end the auction right away by accepting the lowest “buy-it-now” option and if the buyer likes it, he/she is the instant winner no long waiting, the buyer may win the item quickly by this manner

The system also permits the initiator to get a onetime chance to “make his own offer”, that will be accepted or rejected promptly and if accepted by the system, he/she is the instant winner.

The system also permits the initiator/buyer to go for a regular auction and if the buyer thinks that he/she may get even a better price he may initiate the regular auction, and he still get the rewards in case he is the winner. So lots of excitements/fun will be going on in this Auction System.

I claim:

1. A revolutionary auction method/algorithm, that I named it as “Auction-Inverse-System” comprising:
a) Providing the Buyer to Initiate an Auction at any period of time as long as the item is listed in the store and she/he is the first one.
b) Providing the Buyer with all exciting and rewarding options of “buy-it-now” and “make-an-offer” that only is presented to the Auction Initiator only. If accepted she/he may get a very competitive price for the item.
c) The rewards don't ends here; she/he if won the auction will also get rewards in the form of free shipping or some percentage off, or may be presented some coupons that will be applicable in future usage or any combination of rewards that.
d) This Invention is not limited to Online Electronic Commerce Website or computer based auctions but may equally be applicable to Physical Auction Houses.
e) The Invention is also not limited to any single seller, any number of Auctioneers/Sellers may participate in this Auction system and enlist their products/Items on whatever condition they are agreed upon, as long as they fulfill the above mentioned claim (a).
